(19) United States
(12) Patent Application Publication
(10) Pub. No.: US 2026/0221147 A1
(43) Pub. Date: Jul. 30, 2026

(54) METHOD FOR PROCESSING RECORDED AUDIO CONTENT

(71) Applicant: Nomono AS, Trondheim (NO)

(72) Inventor: Iver JORDAL, Trondheim (NO)

(21) Appl. No.: 19/145,447

(22) PCT Filed: Dec. 20, 2023
(86) PCT No.: PCT/EP2023/087157

§ 371 Date: Jul. 2, 2025

(30) Foreign Application Priority Data
Jan. 2, 2023 (DK) PA 2023 70001

(51) Int. Cl. G10L 21/0232; G10L 21/0216; G10L 21/028; G10L 21/034; G10L 21/0364; G10L 25/30

(52) U.S. Cl. CPC G10L 21/0232; G10L 21/028; G10L 21/034; G10L 21/0364; G10L 25/30; G10L 2021/02166

(57) ABSTRACT

The invention concerns a method for processing recorded audio content, said audio content having at least two timely synchronized audio signals recorded by a respective microphone, said microphone associated with a respective sound source, wherein each of the at least two audio signals comprise a speech component associated with the respective sound source and a secondary component unrelated to said respective sound source. The method comprising the steps of separating from each of the at least two audio signals a clean data stem, a crosstalk stem and a noise stem. The various stems are processed individually and then combining back together.

The present application claims priority of DK patent application PA 202370001 dated January 2^{nd}, 2023, the disclosure of which is incorporated herein by reference in its entirety.

The present invention concerns a method for processing recorded audio content as well as to a system configured to perform the method.

### BACKGROUND

Podcast and some other media types require high level audio content to provide the necessary quality the listener and/or viewer of a certain media content expects and requires. In some environment audio recording does not meet those expectations. While in studio recordings, any background noise is usually suppressed efficiently, other environments may contain different background noise, including quiet talks from other persons, noise from machinery nearby, natural sounds and so forth.

As a result, recorded audio is usually processed by the content producer before being published. Such processing usually includes denoising and gaining or loudness correction to improve the listening experience. In modern recordal systems, which are used to record spatial audio content, sound including speech is recorded using a plurality of microphones arranged in various locations. The microphones do not only record the desired sound (e.g. the speech of a person), but also crosstalk whereas the speech of a person is recorded with different microphones. While recording spatial audio provides various benefits increasing a listener's experience, the post-processing also becomes more complicated.

For this reasons, various post processing tools and software have been proposed to improve the quality of the recorded audio. However, it has been experienced that in certain recordings sound processing may result in some kind of uncanny-valley effect for the listener, that is the played audio content sounds artificial and unnatural to a listener. To avoid this effect, significant efforts and time has to be spent by the audio content producer.

It is an object of the present application to improve the listener's experience without adding additional burden to the audio content producer.

### SUMMARY OF THE INVENTION

This and other objects are addressed by the subject matter of the independent claims. Features and further aspects of the proposed principles are outlined in the dependent claims.

It has been found that audio processing of a multiple of recorded audio tracks for noise reduction or crosstalk suppression to produce an audio content often works on the individual tracks. While this is generally useful, it has also been found that such processing is often a reason for the uncanny valley, that is a sound experience felt to be artificial and not natural. In spatial recordings, in which a more effort is taken to produce natural sounding audio content, tuning of the noise reduction, crosstalk suppression, gain of the various channels and others are rather complex and may require several iterations.

Consequently, the inventors propose an improved technique processing recorded audio content, said audio content including separately recorded but timely synchronized audio signals. The concepts propose separating various components in each of the audio signals based on their respective types (further referred to as stems) and then process those types separately for each signal. The various portions (or stems) are then at least partially combined together again after processing them separately. This will allow to optimize processing for the different portions—referred to as stems—individually. Furthermore, as certain processing function are often concerning a specific type, potential interference from other components is minimized.

Based on the audio content being generated, this approach allows to flexibility create a natural sounding environment offering a pleasant listener's experience and avoiding the uncanny valley. At the same time, the separation of each audio signal into the various stems simplifies the computation effort later on and allows a more flexible and individual handling during post processing.

A method for processing recorded audio content is proposed in some aspects, wherein said audio content comprises at least two timely synchronized audio signals recorded by a respective microphone. At least one of the microphones is associated with a respective sound source. Further, each of the at least two audio signals comprise a speech component associated with the respective sound source and a secondary component unrelated to said respective sound source.

Consequently, the proposed method acts on at least two timely synchronized audio signals, wherein at least one of those is associated with a sound source, for example a person. The at least one other microphone of the at least two microphones can either associated with a second sound source or arranged somewhere close by. In the latter case, the at least one other microphone is usually stationary.

The proposed method comprises the step of separating from each of the at least two audio signals a clean data stem, a crosstalk stem and a noise stem. These stems are defined to be the types of sound contained in the audio signal. For the purpose if this application, the following stems are defined as clean data stem, crosstalk stem and noise stem.

The clean data stem comprises substantially the speech component, particularly from the sound source to which the microphone is associated with but is otherwise deprived from other sound portions. In a high-quality studio environment with a single microphone and no sound reflections or other (noise) sources, the recorded audio signal would most likely represent the clean data stem.

The crosstalk stem comprises a crosstalk portion recorded by the microphone associated with the respective sound source. The term crosstalk refers to an audio component that is recorded by a microphone, which is not associated with the sound source causing the audio component. In addition, crosstalk refers to an audio component reflected at a wall or an obstacle but coming from the audio source associated with the microphone. Simply speaking crosstalk often refers to recorded background speech or recorded voices from one or more persons that are not current or desired speakers as well as any reflected portion of the speaker's voice.

It may be that a crosstalk portion is comprehensible to a listener but just degraded, whereas a noise portion does usually not provide useful information to a listener.
while the former audio component is usually different from the direct recorded sound of the sound source, a reflection may have a similar frequency and time distribution, but is delayed, attenuated and phase shifted. Consequently, the latter can also be handled as part of the noise stem.

The noise stem comprises a noise portion of the secondary component. It is defined as a portion of the recorded signal that does not provide useful or derivable information to a listener. It is not related to the sound source but originates from a different source (one can consider reflection as originating from the wall or an obstacle). Typical sound sources are machinery, circuits, sounds of nature like a stream or river flowing. One skilled in the art can identify many more sound sources that produce or contribute to the noise stem in a recorded audio signal.

After separation of the recorded audio signals into the respective stems, each stem of each audio signal can be processed individually. Alternatively, two or more stems from the same audio signal can be processed using the same processing function and parameter set. Here all variations and combinations are possible providing a significant improvement over conventional techniques, in which a certain processing function is applied to the audio signal as a whole, but not to the separate and individual stems.

In particular, the separated stems of each audio signal can be stored in a non-volatile memory for later use.

The method according to the proposed principle proposes to apply a first processing function to the clean data stem of at least one of the at least two audio signals to obtain a first processed clean data stem. Particularly, independently thereof, the first processing function is also applied to at least one of the crosstalk stem and the noise stem of said at least one audio signal to obtain a first processed crosstalk stem and/or first processed noise stem.

In this regard, applying a function to a certain stem or more generally an audio signal or portion thereof means that the respective stem or portion is used as input for said function, such the content of said respective stem is changed or amended accordingly.

The first processed clean data stem is then combined with at least a portion of the first processed crosstalk stem and/or first processed noise stem to obtain a processed combined stem. The processed combined stems of each of the at least two audio signals are subsequently mixed to provide an output signal.

Separation of the recorded audio signals into the different stems provide several advantages over conventional techniques. For one, the processing function subsequently applied to the various stems can be optimized for the respective stem. Furthermore, some processing function will provide better results if applied to only a single stem and not a combination. For example, de-esser and breath detection should preferably only be applied to the clean data stem to avoid identifying noise portions as part of the voice or speech. Likewise, an automated gain control should avoid increasing crosstalk, while the speaker is silent. The proposed principle allows to develop functionality specifically for one of the separated stems that add to the content provider's flexibility when processing audio content.

In some more instances, the step of applying a first processing function to the clean data stem further comprises applying a second processing function to at least one of the clean data stems to obtain at least one processed clean data stem, said at least one processed clean data stem being the input for the first processing function.

Consequently, one can either apply various processing functions to the individual stems, or the same processing function to two or more of the stems prior to combining them back together. It is also possible that an output of a processing function acts as an input for the next processing function. Stems may therefore be processed using a plurality of processing function, wherein some of those processing function are applied to different stems, while other processing functions are used solely on a single stem. Furthermore, depending on the functionality, one may also consider applying certain functions only to stems of dedicated audio signals, and not to each of the recorded audio signals.

The following sections refer to the functionality of certain processing functions. The implementation of those can be different, including for example open-source libraries, but also proprietary solutions. Furthermore, some of the processing functions are static, i.e. the use a fixed algorithm or approach, while other include a trained deep learning network optimized to provide the respective functionality.

In some instances, the second processing function comprises an adaptive equalizing function, configured to frequency-selectively gain or attenuate portions of the clean data stem of at least one of the at least two audio signals. The gain or attenuation can be done one each of the data stems with different parameter sets. This will allow to adjust the volume of different sound sources to a common level without increasing crosstalk and noise.

In addition, it may be useful in some instances, to mute portions of the clean data stem of at least one of the at least two audio signals, particular in those portions, in which no speech by the sound source associated with the at least one audio signal is present. This function is of particular usefulness in cases, in which the different sound sources are persons talking or having a discussion. Muting or at least significantly reducing the volume of those signals not associated with the current speaking person may improve the overall quality, as undesired signal portions from other sound sources are suppressed. This function may be applied to all clean data stems, as it also required to identify speech and pauses in the respective data stems, to be able to mute them selectively.

Consequently, in some aspects, the second function applied to a data stem of one of the at least two audio signals also utilises the other data stems to derive various parameters therefrom including but not limited to markers associated with voice or speech.

Some other function concern improving the actual speech or voice included in the data stem. In some aspects, the second function is configured to reduce or eliminate the excessive prominence of sibilant consonants within the speech component of at least one of the clean data stems of at least one of the at least two audio signals. This is also referred to as de-essing. In some instances, the second processing function comprises a breath detection functionality, configured to evaluate each of the clean data stems of at least one of the at least two audio signals, particularly evaluate those separately from each other, to mark portion of the respective stems, in which a breath by the associated sound source is detected. In some instances, the breath detection, can be subsequently used to adjust the gain of the respective stems, thereby preventing that breathing sounds are increased. Alternatively, the detected breath of a sound source is adjusted automatically, e.g. by attenuating the respective portion.

Some further aspects concern the first processing function, which is a processing function which is applied to one of the data stems or processed data stems (with one or more of the above mentioned second processing functions) and one of the noise stem and the crosstalk stem. The function can be applied with the same parameters to various stems or with different parameter sets. However, the first processing function is applied to those stems separately, which means that the data stems and the noise stem or crosstalk stem are used separately as input to the first processing function. This will provide flexibility, because the results of the processed data, noise and crosstalk stems can be optimized separately by applying the respective function individually.

The first processing function comprises for example a high-pass filtering functionality configured to filter frequency portions below a threshold frequency. The threshold frequency can be set to different values depending on the type of stem (e.g. data, noise and/or crosstalk). The threshold frequency can be in particular below 100 Hz and more particularly below 70 Hz. The high-pass filtering function is applied in particular to one of the clean data stems and one of the noise stems.

In some further instances, the first processing function may comprise an adaptive levelling functionality, configured to frequency-selectively gain or attenuate portions of at least one of the clean data stem of at least one of the at least two audio signals and in particular the noise stem associated with the at least one of the at least two audio signals. Such function may also use markers associated with the voice or speech in the data stem. For instance, by evaluating those markers, one may selectively attenuate or gain the crosstalk and noise stems during time periods, in which no voice or speech is present in the data stem. Such time and stem selective gain may contribute to a more natural listening experience.

In some instances, the step of separating the stems from each of the at least two audio signals comprise the step of separating a crosstalk portion as crosstalk stem from each of the at least two audio signals using the at least two audio signals. Additionally, a noise portion is separated for each of the at least two audio signals, in which in particular the crosstalk portion has already been separated, wherein optionally the two separation steps are subsequently executed. Consequently, the separation is stems is done in two different steps, whereas a crosstalk portion is separated in a first step and a noise portion is separated from the audio signal in a subsequent step. If all three stems are summed up together, one derives again at the recorded audio signals.

It may be useful in some instances to obtain information from the other audio signals to identify the cross-talk portions and thus increasing the performance of the crosstalk separation step.

Some aspects concern the implementation of the separating step. In some instances, the step of separating a crosstalk portion comprises inputting the at least two audio signals into an artificial network, said network being trained to identify crosstalk portion in one of the at least two audio signals, whereas optionally the artificial network utilizes the respective other audio signals to identify crosstalk portions in the one of the at least two audio signals.

In some instances, the audio signals are pre-processed to simplify the subsequent processing steps or adjust the characteristics of the audio signal to align them accordingly. In some aspects, the at least two audio signals are pre-processed prior to separating at least one of the stems from each of the at least two audio signals. Such pre-processing may include the step of re-sampling each of the two audio signals to a common sampling rate, in particular one of 38 kHz, 88.2 kHz, 96 kHz and 192 kHz. In addition or also alternatively, each of the at least two audio signals can be normalised.

It is possible to combine the processed stems in various ways depending on the desired effect, the audio content or the preference of the listener. It has been found generally that a small amount of crosstalk and/or noise adds to the listener's experience, as it is perceived as more natural. Hence, combining at least a portion of the first processed crosstalk stem and/or first processed noise stem into the first processed clean data stem may comprise merging a portion of the separated crosstalk stem of one of the at least two audio signals into least one processed clean data stem of said one of the at least two audio signals.

The combination can take place at various stages but is usually performed after at least one processing function is applied to the data stem. Hence, prior to merging a portion of the noise and/or crosstalk stem back into the data stem, the data stem is processed and adjusted in accordance with the selected processing function. For example, the data stem can be applied to one or more of the second processing functions prior to combining it with a portion of one of the other stems. The noise and crosstalk stem can also be processed prior to merging it with the other stems. The separation of the audio signals into the three different stem types and processing those independently from each other, allows for all permutations of possible combinations thus offering a high degree of freedom of choice.

In some further instances, combining at least a portion of the first processed crosstalk stem and/or first processed noise stem into the first processed clean data stem to provide a processed combined stem comprises merging a portion of the separated noise stem into a stem that comprises the clean data stem processed with a second function and a portion of the crosstalk stem. In such embodiments, a portion of the processed noise stem is combined into the data stem having a portion of the crosstalk stem already merged. The data stem and/or the crosstalk stem may also be processed to the extend that the have been applied to one of the above-mentioned functions.

After merging the various stems back together—or portions of it, a loudness correction and normalisation can be performed on each of the processed combined stems. The results are a plurality of processed audio signals at least one of them associated with a sound source, in which noise and crosstalk are reduced by an individually adjustable portion. Those processed audio signals can now be mixed together in accordance with the desired overall output.

Such mixing can include the evaluation of spatial information, to be able to arrange the processed audio signals in a virtual audio space. This would include binaural format, the ambisonics b-format and others. Alternatively, the audio signals can be mixed into a stereo signal.

In some aspects, the proposed principle further comprises associating a first microphone to a first sound source and at least one second microphone to a second sound source. In addition, an ambisonics microphone array is placed in a sound environment containing the first and second sound source. For the purpose of the present method, one of the microphone is now used to record a respective audio signal and subsequently stored in a non-volatile memory. The format used should be preferably a lossless one to avoid losing information. The use of microphones, whereas each microphone is associated with a dedicated sound source in addition to an ambisonics microphone array offers several benefits. The processing of the audio signal and particular the data and crosstalk stems allow to identify and locate the sound sources in the sound environment.

In a particular embodiment, at least one audio signal is recorded by a mobile microphone and four audio signals are recorded by stationary microphones that are arranged in a fixed position towards each other and timely synchronized with the mobile microphone. Such audio signals offer the possibility to create and manipulate a virtual sound space. The proposed principle supports such application by generating clean data stems with separate information on crosstalk and noise.

Some other aspects concern a system comprising at least two timely synchronized microphones. At least one of said microphones is associated with a sound source and in particular a mobile sound source. The system comprises one or more processors and a storage for storing audio signals recorded by said timely synchronized microphones. A memory comprises a program stored therein, said program including instruction, which, when executed on the one or more processors perform the method according to the preceding claims.

The microphones can be located in different spots and even far away from the processor and memory or storage. Further, the microphone can record the audio signals, which are then uploaded to a storage cloud for subsequent processing. This also promotes workload distribution, whereas one person is responsible for initial recording and a second person is responsible for processing the recorded audio content. Consequently the system may be configured in some instances to transmit recorded audio signals from the at least two timely synchronized microphones via a network to the storage.

In some aspects, the system further comprises a microphone array for recording a third timely synchronised audio signal, wherein the microphone array is configured to time synchronize the at least two microphones. The microphones array may comprise one or more directional microphones having a figure of eight sensitively. The microphone array may act as a master, wherein the at least two microphones associated with the respective sound sources act as slaves. They may be configured as lavaliers microphones.

In this regard, the microphone array comprises an interface for a wireless connection to an access point using for instance a Wifi protocol. Communication between the at least two microphones and the microphone array may use a different protocol for example Bluetooth. The microphone array is configured to transmitting the audio signals recorded by said timely synchronized microphones and the third timely synchronised audio signal to the storage device with the wireless interface.

### SHORT DESCRIPTION OF THE DRAWINGS

Further aspects and embodiments in accordance with the proposed principle will become apparent in relation to the various embodiments and examples described in detail in connection with the accompanying drawings, in which

FIG. 1 shows an embodiment of a method for processing recorded audio content with a plurality of timely synchronized audio signals in accordance with some aspects of the proposed principle;

FIG. 2 illustrates an example of a data object, which can be used to facilitate a method for processing audio content in accordance with some aspects of the proposed principle;

FIG. 3 shows an embodiment for a pre-processing step of a method for processing audio content in accordance with some aspects of the proposed principle;

FIG. 4 illustrates an exemplary method step of separating the respective stem, in accordance with some aspects of the proposed principle;

FIG. 5 shows some exemplary method steps for processing the voice stem in accordance with some aspects of the proposed principle;

FIG. 6 illustrates an embodiment for a processing step applying a certain function to different stem in accordance with some aspects of the proposed principle;

FIG. 7 shows some exemplary method steps for processing the re-combined stem and storing them in a suitable format in accordance with some aspects of the proposed principle;

FIG. 8 illustrates an exemplary sound environment, in which audio content is recorded for being process with a method in accordance with some aspects of the proposed principle.

### DETAILED DESCRIPTION

The following embodiments and examples disclose various aspects and their combinations according to the proposed principle. The embodiments and examples are not always to scale. It goes without saying that the individual aspects of the embodiments and examples shown in the figures can be combined with each other without further ado, without this contradicting the principle according to the invention. It should be noted that in practice slight differences and deviations from the specific embodiments may occur without, however, contradicting the inventive idea. Some steps can be reversed or interchanged with other steps, but it is possible to possible to deduce relations between the elements based on the figures.

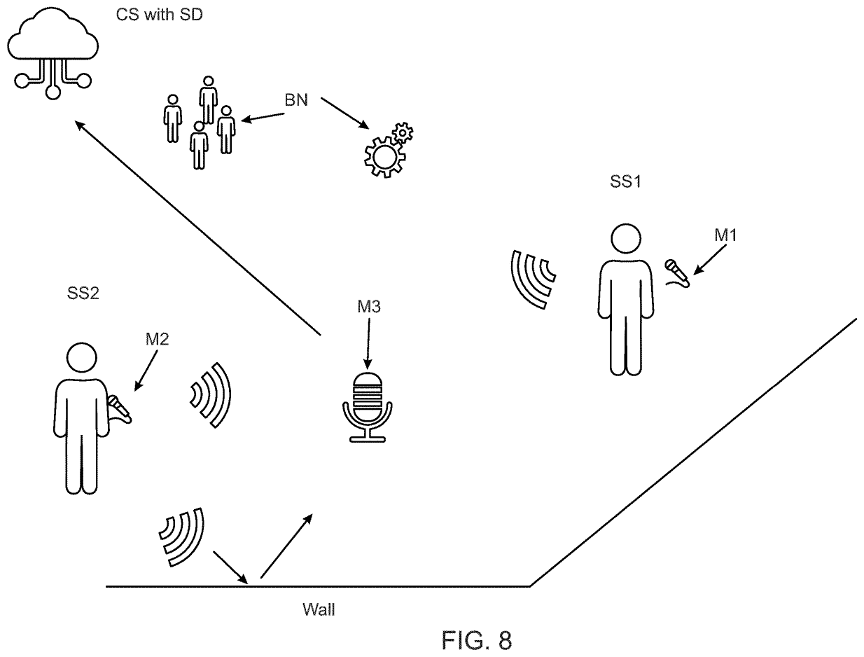

Referring first to FIG. 8, which illustrates an exemplary sound environment, in which audio content is recorded. The sound environment contains two speakers, which are for example having a debate. The speakers are referred to as sound sources SS1 and SS2, respectively. Generally, for the purpose of this application, the term sound source refers to an entity,—most often a speaker—whose sound, i.e. utterance, speech or voice is to be recorded. In contrast thereto, other sound or noise sources, like noise coming from machinery or some background people talking but not intended to be recorded are not considered a sound source. In the sound environment of FIG. 8, each sound source comprises a recording device M1 and M2 associated with and closely arranged to the respective sound source. The recording device M1 and M2 are microphones recording the sound environment and store the recording as a sound signal. In some instances, the microphones M1 and M2 are so called omnidirectional microphones, i.e. the usually do not have a preferred recording directions. The microphones M1 and M2 are often attached to the sound sources body and carried around with them in case the person or sound source is moving.

In addition, the sound environment comprises a third recording device M3, for example in form of a microphone array. The microphone array comprises one or more directional microphones, i.e. figure of eight microphones. The recording device M3 is usually fixed at a dedicated location during the recordal session. All microphones M1 to M3 are timely synchronized, that is their internal clocks are synchronized. They may also record with the same sampling rate. Time synchronization can be achieved in a master slave fashion, for example, in which the recording device M3 triggers the time sync using a wireless transmission. The wireless transmission uses a low energy protocol like Bluetooth or one of it derivates. Consequently, the start time of the recordings for each microphone is either synchronized as well or even equal, that is each microphone starts recording at the same time.

When recording, the microphones record the sound environment and store it in a memory for later processing. The recorded signal may contain several components, which are outlined in greater detail with respect to recording devices M1 to M3. Let's assume sound source SS1 (being a person) is talking. In such instance, the recording device M1 is recording the voice or speech with almost a negligible delay due to its close location to sound source SS1. After a short delay, the speech is also recorded at recording device M3 using the directional microphones. After a further delay, the speech is recorded at the recording device M2 located at sound source SS2. The recorded speech at recording device M1 is referred to as direct speech or direct voice, while the recorded signal at microphone M2 is referred to as crosstalk, due to the fact that it does not originate from sound source SS2. Likewise, when person SS2 is speaking, the voice recorded at recording device M1 is referred to as direct speech, while its recording at microphone M2 is referred to as crosstalk. Usually crosstalk has a smaller amplitude than the original voice and because of the time synchronization or the microphones, one can distinguish between direct speech and crosstalk.

Apart from those direct voice and speech portions being direct voice or crosstalk, the voice can also be reflected at a wall or any other obstacle. Furthermore, any machinery, artificial noises from electric or mechanical devices and even other persons talking may be present in the sound environment and recorded at the respective microphones usually with different delays. The latter are usually incomprehensible. Any noise from such devices as well as the incomprehensible utterance from the background is referred to as background noise BN, while the reflected portion are either also identified as noise or as crosstalk (the identification partially depends on their physical parameters like delay, attenuation, phase shift and so forth).

Consequently, each recorded audio signal may include several superimposed portions of the above types, whereas the ratio of each portion may vary over time. In accordance with the proposed principle these signal portions are categorized into one of the three categories or stems, namely a voice stem, a noise stem and a crosstalk stem. Each stem has its own characteristics making them distinct from each other, but is also characterized by the type of its content.

During recording, the recorded sound is either stored in each of the microphones. In such embodiments each microphone M1 to M3 comprise a respective memory. After recording, the recorded data is transferred to a cloud service CS that stores the recorded data in a structured folder, database or any other suitable location. For data transfer, the microphones M1 and M2 may transfer their recordings first to recording device M3 using a first transmission protocol like for example Bluetooth and the like. The recording device M3 then transmits all audio signals to the cloud service. In a further embodiment, the recording devices M1 and M2 already transmit their recordings during the session to device M3, thereby reducing the amount of their memory needed. Devices M1 and M2 store their recordings only temporary when the wireless connection deteriorates. Array M3 stores the recordings and then transmits them via an access point (not shown in FIG. 8) to the cloud service CS. The latter approach offers a higher flexibility as the recordings can be stored in device M3 till a wireless connection is established to an access point and from there to the cloud service.

The recorded audio signals are stored in a storage device SD as channels, wherein each channel is associated with a recording device and/or microphone thereof. The totality of all channels is referred to as audio content. While the channel contains the recorded audio signal, preferably in a lossless format, it may also comprise certain metadata as explained below. The audio content is transferred to a processing system, that is configured to perform the method according to the proposed principle.

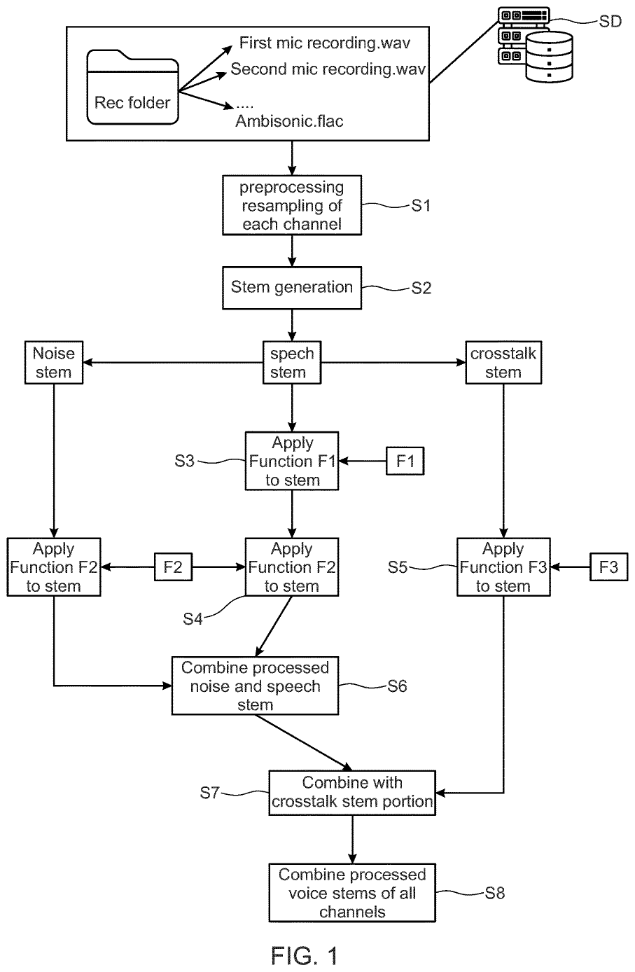

FIG. 1 illustrates an exemplary embodiment of the method for processing audio content in accordance with some aspects of the proposed principle. As stated above, each channel of the audio content contains a signal recorded by a single microphone or a microphone set.

For example, some channels comprise an omnidirectional sound signal, whereas the sound signals are stored in a substantially lossless format. Typical recording formats include the wav format, aiff, alac, PCM, WavPack and the like.

Further, some additional microphones may be arranged in a certain configuration providing directional recording that is stored an ambisonic format. Such directional information, whether those are stored separately or in contained in the audio signal itself can subsequently be used during processing of the signals. Ambisonics and more particular ambisonic B-format can be used to store the signal containing a speaker-independent representation of a sound field.

The various stored files representing the recorded audio content can be organized in folders, such that processing of the individual signals is usually performed in a single loop creating processed audio content. Offline processing is usually performed, that is recording is done separately and independently of subsequent processing.

The separation of recording and processing enables a work split, whereas a producer may record the audio content, upload it to a storage device SD as illustrated in FIG. 1, from which the various recorded audio signals are processed in accordance with a proposed method.

In a first step S1, some pre-processing of the stored audio signals is performed. This includes but is not limited to re-sampling of the respective signals to a common sampling rate. In particular, the common sampling rate is higher than the sampling rate at which the audio signals are stored. Re-sampling to a higher sampling rate may increase computational effort later on, but also produces better results for the individual channels and allow additional functionality like position estimation with higher accuracy. Typical sampling rate may include, but are not limited to 48 kHz, 96 kHz and 192 kHz. Furthermore, as all channels and signals are timely synchronized, one may consider offset removal or initial cutting prior to processing to avoid processing portions of the audio content, that is either uninteresting or will not be used in the final audio product.

In a subsequent step S2, a stem separation is performed to separate the above mentioned three different signal portions in each audio signal from each other, that is in each channel from each other. This step is performed depending on the nature of the signal portion. For example, crosstalk portion may be separated first using either fixed algorithm or trained deep learning networks for identifying the crosstalk and separating it from the channel.

For this purpose, it is suitable to also evaluate the other channels. In the present embodiment for example, the channels of the first two recording devices M1 and M2 are evaluated together with support from the recorded signal of microphone M3, as devices M1 and M2 are usually recording the crosstalk. In other words, to separate the crosstalk in each stem, the proposed method utilizes the audio signal on the other channels. The identified crosstalk for each channel is separated from the original signal, such that the respective signal in each channel now only comprise the noise and the voice stems. The identified crosstalk is stored separately for each channel.

In a next step and/or parallel to the identification and separation of the crosstalk stem, the noise is identified and subsequently separated from the remaining signal in each channel. Similar to the crosstalk stem, the identified noise stem is subtracted from each signal, leaving only the voice stem. The identification and separation can be changed, i.e. the noise is identified first and separated from the original signal. In any case, each channel (i.e. each audio signal) may finally comprise a noise stem including all types of background noise, a crosstalk stem including the identified crosstalk portion and a voice or speech portion including the substantially pure speech portion included in the original signal. With two recording devices and a microphone array having six directional microphones, one obtains up to 24 different stems, although not each and every stem is required for the following process steps.

Following the next steps in the method in accordance with the proposed principle, each stem can now be processed separately. For this purpose, the respective stem is used as input to a function, tweaking the stem or portions thereof and providing a processed output stem. This is also referred to as applying a function to one or more stems. Examples of possible functions are presented herein further below. Functions can be mixed and its parameter, if any, altered depending on the desired results. It is noted that for the present application, simply removing or attenuating a noise and/or crosstalk stems is not considered a function. Rather, applying a function to a stem will alter the stems or portions of it, but also provide an output that is processed further in subsequent steps.

As illustrated in FIG. 1, function F1 is applied to the separated voice or speech stem and produces a processed speech stem in step S3. The nature of function F1 is such that it is suitable mainly for the voice and speech stem, but not for the other two types of stems. The crosstalk stem is input into function F3 in step S5, altering the crosstalk stem and providing a processed crosstalk stem.

Some functions expect an input from two or more stems. For example, function F2 can process the noise stem and the voice stem or processed voice stem as an input as illustrated in step S4. The function F2 processes both of them separately, that is without any interference of any of the two stems to the respective other. Consequently, a function is applied to the processed voice stem and separately thereof to the noise stem. Examples for functions that are suitable to process the noise or crosstalk stem and the voice stems are provided further below.

Several of such functions can be applied to the respective stem to alter portions of it as deemed necessary. In contrast to conventional processing methods, the proposed principle provides a greater flexibility and adjustment possibilities, as the stems for each channel are processed separately and optionally independent form each other. In some instances, common parameters can be used for the respective function in some of the channels and/or stems. This will allow a fast and efficient workflow for processing the audio content.

The processed stems or portions thereof are then combined back together in step S6. It has been found that processing the voice alone and having it as final audio content often sounds artificial and not natural. Hence, it is suitable to combine some processed noise or also crosstalk and other undesirable signal portions with the processed voice stem to create a more natural hearing experience. The level of the process stem is usually smaller than the original noise level to improve the overall audio content, but also prevent the impression of an “artificial speech” or “artificial voice”.

Likewise, a portion of the processed crosstalk stem is then combined into the already combined noise and voice stems in step S7. The result is an even more natural sound experience. The processed channels with the adjusted and processed voice stems are then mixed together. Additional processing can be performed including but not limited to spatial audio like binaural mixing, ambisonics, stereo mixing and the like. In addition, the result can be downsampled or finally stored in a lossy format like AAC or mp3.

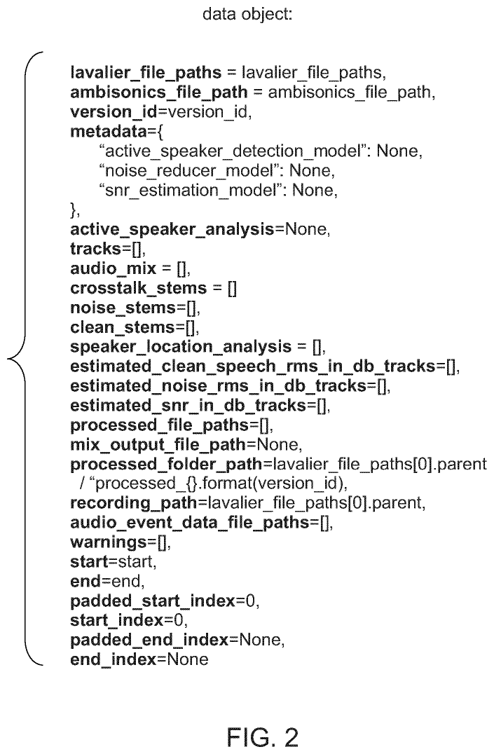

FIG. 2 shows an embodiment of a data object for an audio content in more detail. The data object includes the original audio content, and also the individual stems, parameters of the respective applied functions and the overall results. Some parameters or results of measurements are stored herein as well. Hence, the data object provided therein together with the method according to the proposed principle offers a non-destructive processing enabling a user to supervise and undo settings or revise processed stems.

The data object includes the path and name of the recorded sound signal for the individual recording devices associated with the sound sources. These are referred to as “lavalier_file_path”. In addition, the data object includes the path to a recorded sound signal in the ambisonics file format called “ambisonics file_path”. This file includes the recorded sound signal of a microphone array that provides directional information in the sound signal itself. With these two information, the data object includes the original audio content.

The data object also provides meta data like for instance, the respective functions applied to the audio content. This is useful to be able to compare the different functions and algorithm to select the optimal one.

Additional fields in the data object are mainly empty and will be filled when the original audio content is processed. For example, the fields crosstalk stem, noise stem and clean stems will include a list of separate files containing the crosstalk, noise and voice stems of each of the audio signals stated in the above-mentioned paths. Further information like the rms value of SNR or noise are included there as well. Those parameters and values are included if they are re-used at various stages of processing the audio content thereby reducing the computational effort.

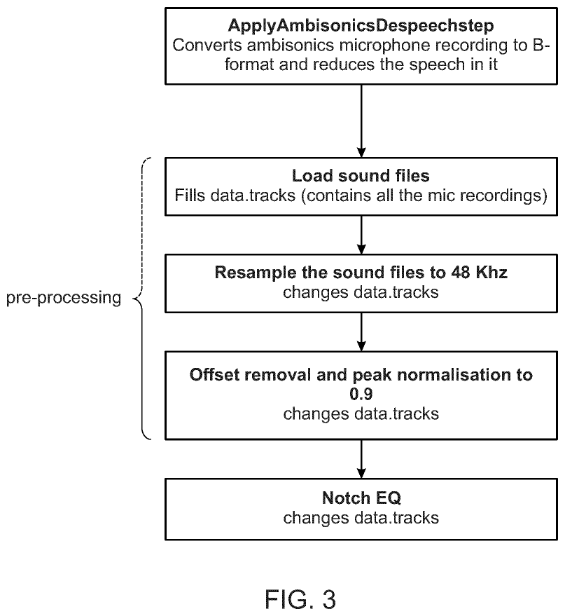

FIG. 3 provides an example for various steps during pre-processing each of the audio signals. The audio signals are synchronized in time. In an initial yet optional step, the ambisonics microphone recordings are converted into B-format. The sound files are also loaded into a cache memory to speed up the processing process. This step is useful in subsequent process step, e.g. during identification and separation of the crosstalk in the various sound signals. The sampling rate for each of the sound files is extracted and identified. If needed a resampling may be performed to sample all sound files mentioned in the embodiment as data tracks to a common sampling rate of 48 kHz. Possible offsets are identified and removed and a peak normalisation to 0.9 is done to avoid clipping of the signals during processing.

Finally, an optional first notch EQ filter to identify and reduce notches in the respective audio signal is applied. The notch filter acts on the superimposed portion, including voice, crosstalk and noise on each signal. Usually, a notch EQ filtering is used to suppress or reduce peak noises occurring at certain frequencies with a relatively large amplitude.

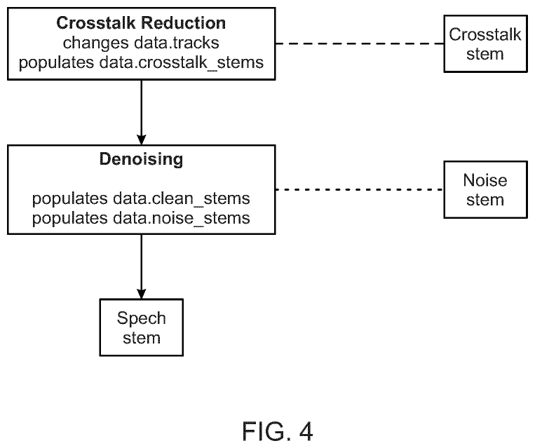

After pre-processing the various audio signals, each individual channel is separated into the respective voice, noise and background stems. The separation may be achieved independently from any processing of the signal. However, it may also be suitable in some instances, to process the audio signals of each channel by applying a respective function for identifying the respective portion of the signals. FIG. 4 illustrate a respective embodiment, in which crosstalk and noise is identified, populated in an additional stem and subsequently subtracted from the input signal to obtain the pure voice stem.

In a first step of the separation process, the crosstalk is identified using a trained deep learning model. The learning model uses one channel (or pre-processed audio signal) as input and the respective other sound signals to identify the crosstalk portion taking the delay, reflections and the different levels into account. For the exemplary sound environment of FIG. 8, each signal of recording devices M1, M2 and M3 can be used as input with the respective other ones to identify the crosstalk portion. Usually, crosstalk is delayed compared to the direct speech and may also be attenuated. The identified crosstalk portion is populated into a different stem and subsequently subtracted from the original audio stem.

The changed audio signal is then fed into a denoiser that identifies the noise portion in the remaining signal. Noise can have different sources, and may partially within the frequency range of the human voice. A trained deep learning model may be used as a denoiser. In some instances, one can use as series of different denoisers including for example a trained deep learning model for identifying the dynamic noise and a static denoiser. The learning model and/or the algorithm may often depend on the type of noise to be removed from the signals. The denoiser, like the crosstalk reducer includes settings that allow a user to identify the noise and/or crosstalk but also select the amount of the respective portion to be removed.

Like for the crosstalk reducer, the identified noise is used to populate the noise stem and subsequently subtracted from the audio signal. This will result in a remaining portion deprived from crosstalk and noise, referred to as voice or speech stem. The process is repeated until the respective stems for each channel are separated.

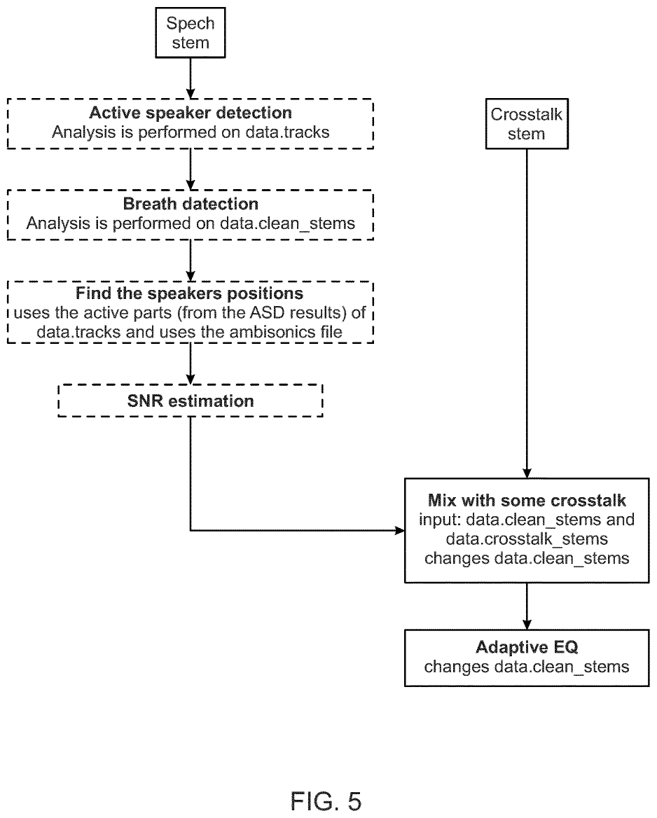

The various stems are then processed separately, and different functions are applied to them. FIG. 5 illustrates some exemplary functions to be applied to the voice stem. Some of these functions are optional and/or interchangeable with other functionalities. This approach allows to select the respective functions to be applied to the voice stem depending on the desired result. Further, new functions can be implemented, as the original voice stem is stored in the data object. This will also allow comparing different processed voice stems with each other to select the adjustments and parameters giving the best performance.

The speech and voice stems are input into a first function, whose output is then subsequently fed into further functions causing a chain processing. In particular, the speech stem is evaluated to detect the active speaker and mark the stem accordingly. This function is performed separately and will add some meta information into the stem. The function does not alter the actual voice stem but simply analyses it and generates meta data including one or more time stamps therefrom.

Likewise, the voice stem is input onto a function for detecting the speaker's breath. Recorded breath usually comprises certain frequencies accompanied with a specific level and wave form. It is usually audible and can create an uncomfortable experience to a listening person. The voice stem is analysed using a dedicated trained deep learning network. The sections, in which breath is detected are marked accordingly. At later processing stages these sections are not enhanced or amplified, but may rather be attenuated slightly. In an alternative embodiment, the breath detection function may attenuate the sections in which breath is detected. Breath detection is applied at least to the voice stems of the direct speech and if needed also to the channels of the ambisonic file.

In addition, the active parts (as identified in the active speaker detection for example) of the voice stems of all channels are used to identify and locate the speakers position in the sound environment. It is suitable in some instance in this regard to also use information in the ambisonics file. For the detection of the position speaker, one can analyse the time delay and phase shift of the various signal with respect to the location of a reference point. In the example of FIG. 8, the reference point is the location of the recording device M3. Furthermore, while this function is applied to the respective voice stems, it may be suitable in some instances to use the crosstalk portions of the respective signals as input parameter. The information about the position is later used to selectively gain or attenuate the respective speaker, but also to adjust the sound environment, or example create a virtual listener and place the sound sources in the desired distance and angle from the virtual listener.

The voice stem is also analysed with regard to the signal-to-noise ratio. All the above functions are used mainly to analyse the voice stem with the results being stored in the data object for later use. However, processing the voice stems are not limited to such steps. Rather, it is possible the voice stems are altered. For example, a level gain EQ can be applied to adapt the individual voice stems to a common level.

In contrast to the processing and analysing the speech and voice stems, the crosstalk stem is left unaltered. A portion of each of the crosstalk stems is then mixed with the respective one of the analysed and processed speech stems. The portion of the crosstalk stem, for example an attenuated version thereof is added to the processed an analysed voice stem for each channel. The result will then include the processed voice and speech portion and a part of the crosstalk. The combined stem is subsequently equalized using a trained deep learning model or an algorithm with adjustable parameters. The adaptive EQ is applied to the combination of the speech stem and the portion of the crosstalk stem and not to the stems individually.

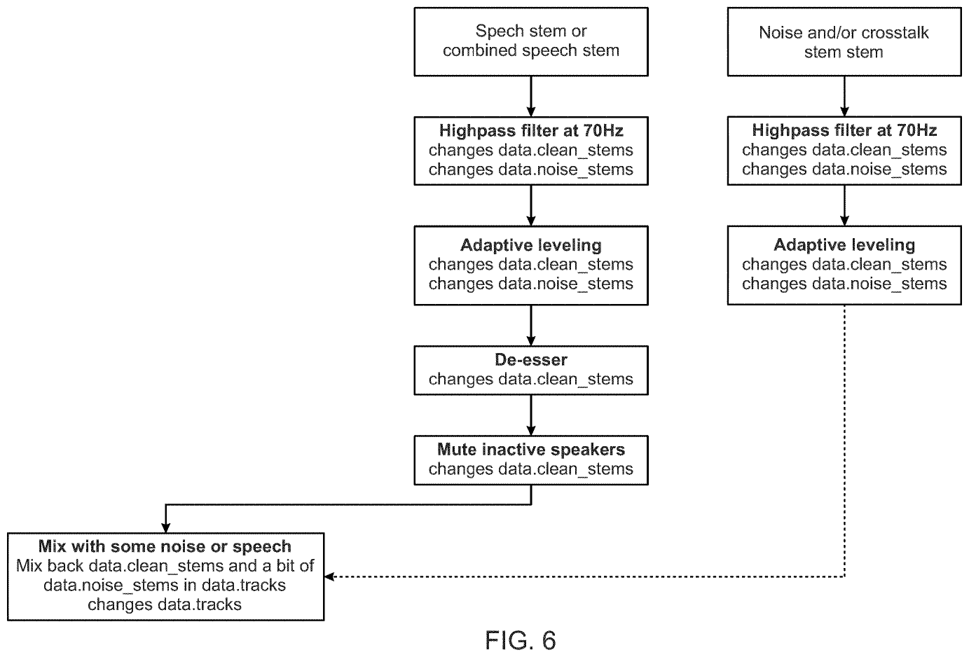

Following the next steps of the process illustrated in FIG. 6. These functions are optional, adjustable and can be interchanged with the analysis functions illustrated in FIG. 5. However, it may be useful to perform any analysis prior to altering the respective stems.

The combined speech stem or alternatively the speech and voice stem separately (after being analysed for example) is filtered using a high pass filter with a cut-off frequency at 70 Hz. The filter will reduce any left-over noise portion in the speech stem, but also low frequency components of the speech. It has been found that its presence or absence will not deteriorate the listener's experience. This high-pass filter is also applied to the noise and/or crosstalk stems using the same cut-off frequency. In the same way an adaptive levelling function is applied to the speech stem (or the combined speech stem) as well as to the other stem(s). In the specific example of FIG. 6, the noise stem and the combined speech stem are altered. The respective target level for the adaptive levelling can be pre-set or individually adjusted for each stem. Similar to the other function it is possible to use previously evaluated meta data for the adjustment. Further, the pre-set parameter may be set globally that is for each channel and not only individually for each stem.

Consequently, the present method proposes to apply certain functions either separately to one or more stems or combine stems together and then apply a function to it. Depending on the function, the results will be improved in comparison to conventional techniques, in which the audio signal as a whole is processed.

Further illustrated in FIG. 6 are two more functions that are applied to the combined speech stem or alternatively to the pure speech stem. These functions are a de-esser that identifies and attenuates sibilants in a speaker's voice and a mute of inactive speakers. The latter can re-use the results of the active speaker detection, or identify silent portions in a speech combined speech stem and mute them. In more complex situations, this function improves the comprehensibility. Both functions improve the listener's experience in more complex sound environments, in which a plurality of speakers are present and partially talking at once.

It has been found that complete removal of background noise is often perceived as artificial, particular in environments, in which some background noise is expected. For example a studio recording is different compared to an outdoor interview, or a recording in front of an audience. To create a more natural sound experience, a portion of the processed noise stem is mixed together with speech stem and/or the processed speech stem. This may lead to situation, in which an audio signal contains the speech portion, that is gained or processed in a first way, while noise and crosstalk portions are processed differently. Depending on the functions applied on the individual stems, the end result after combining the processed stems may not be possible, when the audio signal is processed as a whole as in conventional systems.

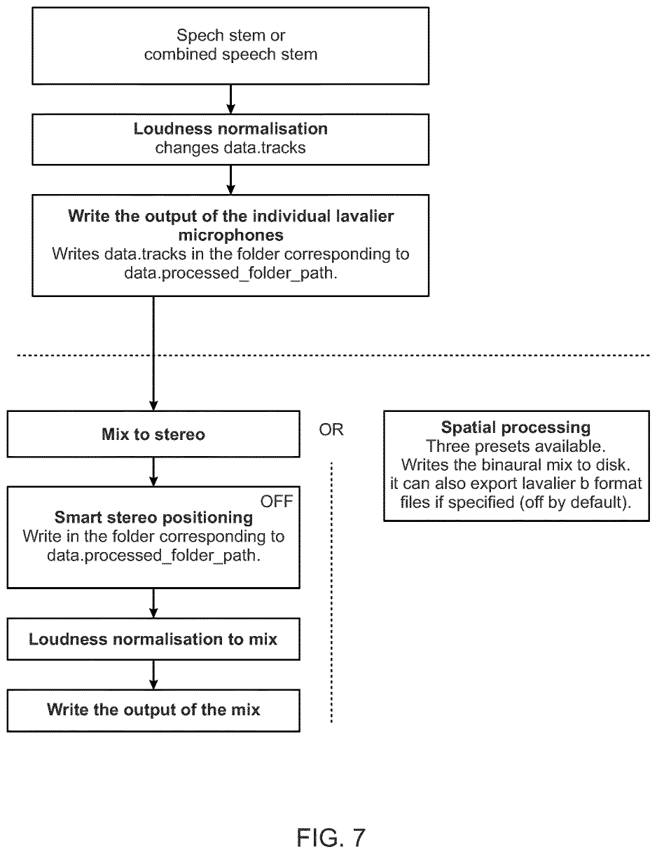

Finally, a postprocessing functions are applied on the overall mixed speech, noise and crosstalk stems as depicted in FIG. 7. For example, this may include a loudness normalisation. Loudness normalization is a process to change the gain to bring the average amplitude to a target level across the overall recording. This average can be a simple measurement of average power, such as the RMS value, or it can be a measure of human-perceived loudness, such as that offered by ReplayGain, Sound Check and EBU R128. Standard loudness normalization reference level varies by location and application. Loudness normalization is applied to at least the channels for the main speakers or direct voices.

Finally, the audio signals are stored back in accordance with the path specified in the data object. The data object then comprises the processed audio signal of the recording devices associated with the respective sound sources.

The data object can then be used to mix the channels in accordance with the desired output. Several options are possible herein, as shown in FIG. 7. In some instances, the stored audio signal re mixed to a stereo signal. However, die to the position information obtained by the proposed method, it is possible to apply optional smart stereo positioning, in which the virtual position of the sound sources can be varied and adjusted on the two stereo channels. Optionally a further loudness normalisation is applied to the mix and the results is written in the desired format.

Alternatively, the processed audio signals are applied to spatial processing with different presets. This allows to generate a binaural mix that is saved to memory. The sound files can also be exported in the ambisonics b format.

### LIST OF REFERENCES

M1, M2 recording devices
M3 ambisonics recording device
SS1, SS2 sound source
BN background noise
SD storage device

1. A method for processing recorded audio content, said audio content having at least two timely synchronized audio signals recorded by a respective microphone, said microphone associated with a respective sound source, wherein each of the at least two audio signals comprise a speech component associated with the respective sound source and a secondary component unrelated to said respective sound source; the method comprising the steps of:
separating from each of the at least two audio signals a clean data stem, a crosstalk stem and a noise stem, whereas
the clean data stem comprises substantially only the speech component,
the crosstalk stem comprises a crosstalk portion of the secondary component of the other ones of the at least two sound sources, and
the noise stem comprises a noise portion of the secondary component;
applying a first processing function to the clean data stem of at least one of the at least two audio signals to obtain a first processed clean data stem;
applying—particularly independently—the first processing function to at least one of the crosstalk stem and the noise stem of said at least one audio signal to obtain a first processed crosstalk stem and/or first processed noise stem;
combining at least a portion of the first processed crosstalk stem and/or first processed noise stem into the first processed clean data stem to provide a processed combined stem; and
mixing the processed combined stems of each of the at least two audio signals to provide an output signal.

2. The method according to claim 1, wherein the step of applying a first processing function to the clean data stem further comprises:
applying a second processing function to at least one of the clean data stems to obtain at least one processed clean data stem, said at least one processed clean data stem being the input for the first processing function.

3. The method according to claim 2, wherein the second processing function comprises at least one of:
a breath detection function, configured to evaluate each of the clean data stems of at least one of the at least two audio signals, particularly evaluate those separately from each other, to mark of the respective stems, in which a breath by the associated sound is detected;
an adaptive equalizing function, configured to frequency-selectively gain or attenuate portions of the clean data stem of at least one of the at least two audio signals;
a muting function configured to mute portions of the clean data stem of at least one of the at least two audio signals, in which no speech by the sound source associated with the at least one audio signal; and
de-essing function configured to reduce or eliminate the excessive prominence of sibilant consonants within the speech component of at least one of the clean data stem of at least one of the at least two audio signals.

4. The method according to claim 1 wherein the first processing function comprises at least one of:
a high-pass filtering function configured to filter frequency portions below a threshold frequency, said threshold frequency in particular below 100 Hz and more particularly below 70 Hz, wherein the high-pass filtering function is applied in particular to one of the clean data stems and one of the noise stems; and
an adaptive levelling function, configured to frequency-selectively gain or attenuate portions of at least one of the clean data stem of at least one of the at least two audio signals and in particular the noise stem associated with the at least one of the audio signals.

5. The method according to claim 1, wherein separating from each of the at least two audio signals comprises:
separating a crosstalk portion as crosstalk stem from each of the at least two sound using the at least two audio signals; and
separating for each of the at least two audio signals, in which in particular the crosstalk portion has been separated, a noise portion from each of the at least two audio signals; wherein optionally the two separation steps are subsequently executed.

6. The method according to claim 5, wherein the step of separating a crosstalk portion comprises;
inputting the at least two audio signals into an artificial network, said artificial network having been trained to identify crosstalk portion in one of the at least two audio signals, whereas optionally the artificial network utilizes the respective other audio signals to identify crosstalk portions in the one of the at least two audio signals.

7. The method according to claim 1, further comprises prior to separating from each of the at least two audio signals at least one of:
re-sampling each of the two audio signals to a common sampling rate, in particular one of 38 kHz, 88.2 kHz, 96 kHz and 192 kHz; and
normalising each of the at least two audio signals.

8. The method according to claim 1, wherein combining at least a portion of the first processed crosstalk stem and/or first processed noise stem into the first processed clean data stem comprises:
combining a portion of the separated crosstalk stem of one of the at least two audio signals into least one processed clean data stem of said one of the at least two audio signals, in particular prior to applying the first processing function.

9. The method according to claim 1, wherein combining at least a portion of the first processed crosstalk stem and/or first processed noise stem into the first processed clean data stem to provide a processed combined stem comprises;
combining a portion of the separated noise stem into a stem that comprises the clean data stem processed with a second function and a portion of the crosstalk stem.

10. The method according to claim 1, wherein mixing the processed combined stems comprises:
loudness normalisation of each of the processed combined stems.

11. The method according to claim 1, further comprising:
associating a first microphone to a first sound source and at least one second microphone to a second sound source;
arranging an ambisonics microphone in a sound environment containing the first and second sound source;
recording with each of the microphone a respective audio signal; and
storing the recorded audio signals, in particularly in a lossless format.

12. The method according to claim 1, wherein at least one audio signal is recorded by a mobile microphone and four audio signals are recorded by stationary microphones that are arranged in a fixed position towards each other and timely synchronized with the mobile microphone.

13. A system comprising:
at least two timely synchronized microphones, at least one of said microphones associated with a sound source, in particular a mobile sound source;
one or more processors;
a storage device for storing audio signals recorded by said timely synchronized microphones; and
a memory having a program stored therein, said program comprising instructions, which when executed on the one or more processors perform a method for processing recorded audio content, said audio content having at least two timely synchronized audio signals recorded by a respective microphone, said microphone associated with a respective sound source, wherein each of the at least two audio signals comprise a speech component associated with the respective sound source and a secondary component unrelated to said respective sound source; the method comprising the steps of:
separating from each of the at least two audio signals a clean data stem, a crosstalk stem and a noise stem, whereas
the clean data stem comprises substantially only the speech component,
the crosstalk stem comprises a crosstalk portion of the secondary component of the other ones of the at least two sound sources, and
the noise stem comprises a noise portion of the secondary component;
applying a first processing function to the clean data stem of at least one of the at least two audio signals to obtain a first processed clean data stem;
applying—particularly independently—the first processing function to at least one of the crosstalk stem and the noise stem of said at least one audio signal to obtain a first processed crosstalk stem and/or first processed noise stem;
combining at least a portion of the first processed crosstalk stem and/or first processed noise stem into the first processed clean data stem to provide a processed combined stem; and
mixing the processed combined stems of each of the at least two audio signals to provide an output signal.

14. The system according to claim 13, further configured to transmit recorded audio signals from the at least two timely synchronized microphones via a network to the storage.

15. The system according to claim 13, further comprising a microphone array including two or more directional microphones for recording a third timely synchronised audio signal, wherein the microphone array is configured to time synchronize the at least two microphones.

16. The system according to claim 15, wherein the microphone array is configured to wirelessly connect to an access point for transmitting the audio signals recorded by said timely synchronized microphones and the third timely synchronised audio signal to the storage device.
